(19) United States
(12) Patent Application Publication
(10) Pub. No.: US 2023/0106540 A1
(43) Pub. Date: Apr. 6, 2023

(54) VIRTUAL-PRESENCE GUIDELINES SOLUTIONS

(71) Applicant: International Business Machines Corporation, Armonk, NY (US)

(72) Inventors: Celia Cintas, Nairobi (KE); Girmaw Abebe Tadesse, Nairobi (KE); Komminist Weldemariam, Ottawa (CA)

(21) Appl. No.: 17/493,797

(22) Filed: Oct. 4, 2021

(51) Int. Cl. H04L 12/18; G06K 9/00; G06N 3/04

(52) U.S. Cl. CPC H04L 12/1822; G06K 9/00711; G06K 9/00335; H04L 12/1831; G06N 3/04; G06K 2009/00738

(57) ABSTRACT

An exemplary method includes intercepting data in a virtual presence solution; classifying the intercepted data against machine-readable conduct guidelines by processing the intercepted data in a neural network; and intervening in the virtual presence solution in response to a component of the intercepted data being classified to a match with at least one of the machine-readable conduct guidelines.

### BACKGROUND

The present invention relates to the electrical, electronic, and computer arts, and more specifically, to virtual presence technologies.

Virtual-presence solutions, using visual technologies such as video conferencing or 3-D avatar models, are increasingly prevalent. Many companies, events/gatherings (e.g., conferences, meetings), etc. put in place social conduct guidelines which must be followed at the workplace, during events. However, adherence to these social conduct guidelines is hard to track, detect or intervene during virtual events. Therefore, interventions to remediate or mitigate non-adherence to social conduct guidelines typically are not real time, incomplete, and otherwise are not scalable to ever-growing virtual interactions.

### SUMMARY

Principles of the invention provide techniques for improving visual virtual-presence solutions. In one aspect, an exemplary method includes intercepting data in a virtual presence solution; classifying the intercepted data against machine-readable conduct guidelines by processing the intercepted data in a neural network; and intervening in the virtual presence solution in response to a component of the intercepted data being classified to a match with at least one of the machine-readable conduct guidelines.

One or more embodiments of the invention or elements thereof can be implemented in the form of a computer program product including a computer readable storage medium with computer usable program code for facilitating the method steps indicated. Furthermore, one or more embodiments of the invention or elements thereof can be implemented in the form of a system (or apparatus) including a memory that embodies computer executable instructions, and at least one processor that is coupled to the memory and operative by the instructions to facilitate exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

In view of the foregoing, techniques of the present invention can provide substantial beneficial technical effects. For example, one or more embodiments provide one or more of:

Adapting existing guidelines of a company to a virtual work environment and other contexts, such as different geographical locations.

Advance anticipation of potential counterproductive interactions in real time using a plurality of data sources such as video, audio, text, and avatar activities.

Automated detection of one or more violations of one or more social conduct guidelines.

Estimation of incident severity score due to one or more violations of one or more social conduct guidelines, weighted on given set of guidelines, to generate interventions accordingly.

Automated generation of interventions and corrective actions against detected social conduct guidelines.

Identification of ‘passive’ counter-productive interactions against detected social conduct guideline.

Improvement in the technological process of computer-implemented virtual interaction by avatar to enforce social conduct guideline adherence.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a guidelines monitor system and components thereof, according to an exemplary embodiment.

FIG. 4 depicts a guidelines extractor of the system of FIG. 3, according to an exemplary embodiment.

FIG. 5 depicts in more detail inputs and outputs of the guidelines extractor of FIG. 4, according to an exemplary embodiment.

FIG. 6 depicts an incident detector of the system of FIG. 3, according to an exemplary embodiment.

FIG. 7 depicts an interventions generator of the system of FIG. 3, according to an exemplary embodiment.

FIG. 8 depicts a method implemented by the system of FIG. 3, according to an exemplary embodiment.

FIG. 9 depicts a proactive method implemented by the system of FIG. 3, according to an exemplary embodiment.

FIG. 10 depicts a computer system that may be useful in implementing one or more aspects and/or elements of the invention, also representative of a cloud computing node according to an embodiment of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

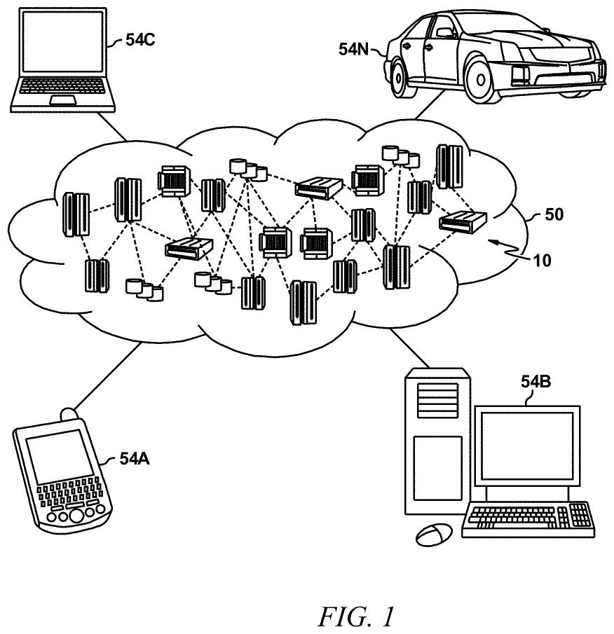

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

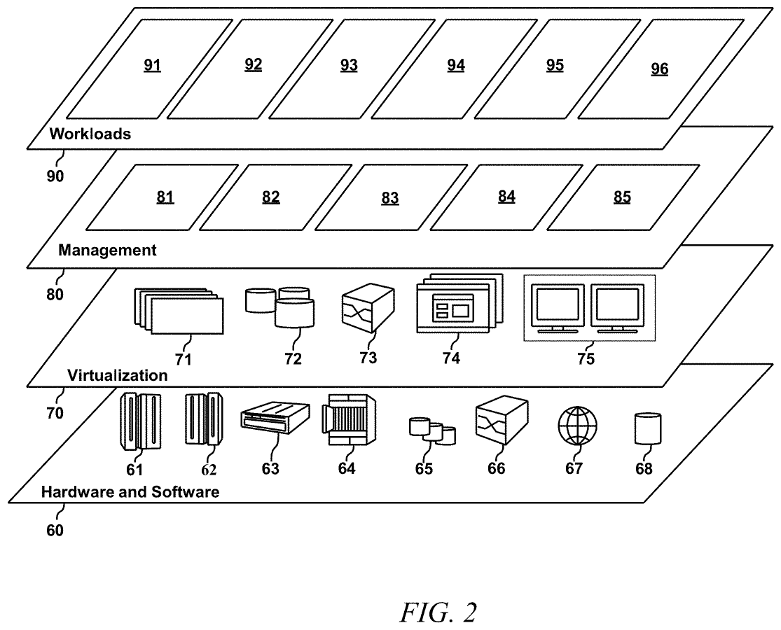

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a social guidelines adherence monitoring system (guidelines monitor) 96.

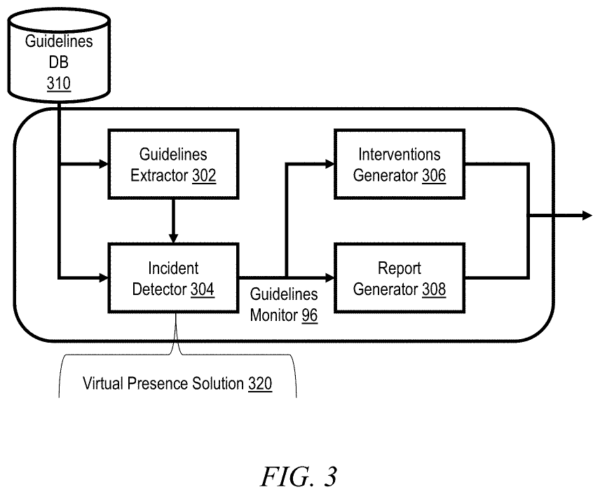

FIG. 3 depicts the guidelines monitor 96 and principal components thereof. The guidelines monitor 96 includes a guidelines extractor 302, an incident detector 304, an interventions generator 306, and a report generator 308. The report generator 308 takes as input the incidents that did not adhere the guideline and provides the receiving participants a secure channel to report these in a secure manner, e.g., the channel might contain instructions on how to report the offenders and the incidents in addition to the contact details of enforcing institutions and/or persons. The guidelines extractor 302 and the incident detector 304 interface with a guidelines database 310, as further discussed below. The incident detector 304 also interfaces with a virtual presence solution 320. A virtual presence solution can include multiple factors. For example, a virtual presence solution may enable a user to see a virtual “room” that the user and others are occupying, and with the ability to move around and interact with other participants based on participants' locations in the room, in a manner similar to a physical, real-life, meeting room. In such a solution, users easily start and end side conversations and chats, or return to a main speaker, just as at a real-world conference or other gathering. Rather than being moved to a breakout room, the user can simply walk her or his virtual-self to tables and chairs, sit down, and start a conversation. A virtual presence solution will typically have one or multiple channel(s) for interaction with other participants (avatars in a given scenario, audio, video or written communications). In one or more embodiments, the incident detector 304 monitors transactions in the virtual presence solution 320 in real time and compares each transaction to guidelines that are produced by the guidelines extractor 302 using natural language processing on the guidelines database 310. In one or more embodiments, the incident detector 304 alerts the interventions generator 306 of transactions that match one or more of the guidelines. In one or more embodiments, the interventions generator 306 responds with remedial measures to the transactions that match the guidelines.

In one or more embodiments, the guidelines monitor 96 mediates the transactions in the virtual presence solution 320, i.e. the incident detector 304 and the interventions generator 306 process each transaction before the transaction is published or implemented via the virtual presence solution, and one potential remedial measure is to block publication or prohibit implementation of a transaction that matches (violates) one or more of the guidelines produced by the guidelines extractor 302. Other potential remedial measures include popup windows displaying the guidelines; private automated chat with users potentially offended by a transaction that matches a guideline, in order to recommend incident reporting options or to provide a communication channel with event organizers; imposition of a time out on a user who promotes an offensive transaction. Apart from interventions, in one or more embodiments the guidelines monitor 96 produces automatic alerts and reports to, e.g., an event organizer or a company manager.

In one or more embodiments, one or more components of the guidelines monitor 96 are implemented as neural networks. Generally, a neural network includes a plurality of computer processors that are configured to work together to implement one or more machine learning algorithms. The implementation may be synchronous or asynchronous. In a neural network, the processors simulate thousands or millions of neurons, which are connected by axons and synapses. Each connection is enforcing, inhibitory, or neutral in its effect on the activation state of connected neural units. Each individual neural unit has a summation function which combines the values of all its inputs together. In some implementations, there is a threshold function or limiting function on at least some connections and/or on at least some neural units, such that the signal must surpass the limit before propagating to other neurons. A neural network can implement supervised, unsupervised, or semi-supervised machine learning.

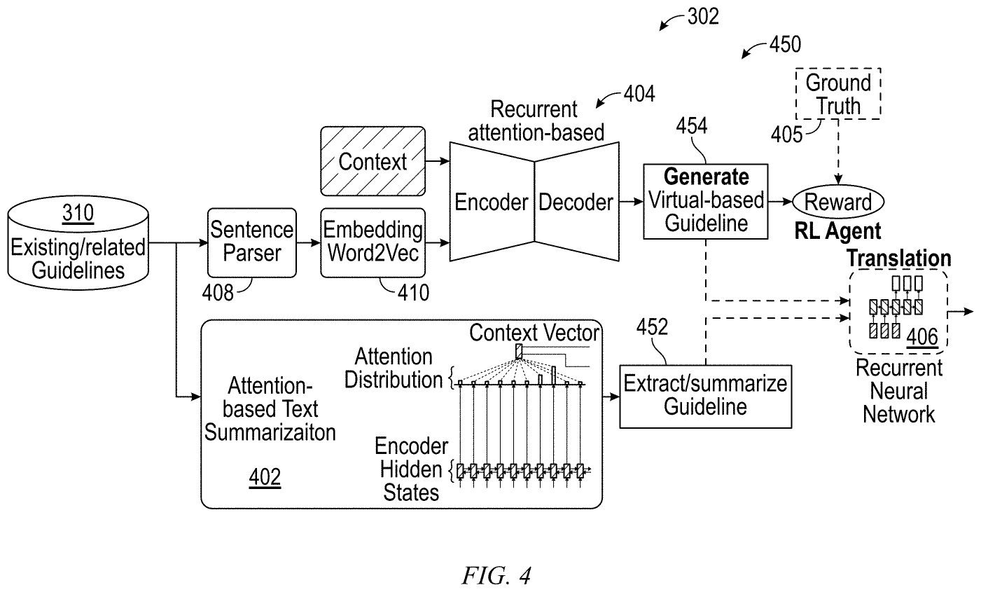

FIG. 4 depicts the guidelines extractor 302, components thereof, and a method 450 that the guidelines extractor implements. If there is an existing guideline, suited for virtual meetings/work environment, an attention-based text extraction and summarization algorithm 402 (natural language processing) is applied to obtain short, informative and machine-interpretable guideline content. That is, at 452 the text extraction and summarization algorithm 402 extracts higher-level features from the guidelines database 310. When guidelines specific to virtual interactions do not exist, at 454 the guidelines extractor 302 generates/modifies one or more new guidelines from related physical world guidelines, using an encoder-decoder framework 404 that employs recurrent neural networks in reinforcement learning setting. As ground truth 405, the encoder-decoder framework 404 uses a set of virtual transactions that one or more subject matter experts have determined would violate the physical world guidelines. A sentence parser 408 and a context embedder 410 feed the encoder-decoder framework 404 from the guidelines database 310. The sentence parser 408 segments each sentence in a social guideline document. Each sentence will be mapped into an embedded vector, which along with the context information, will be fed into the guideline generation framework.

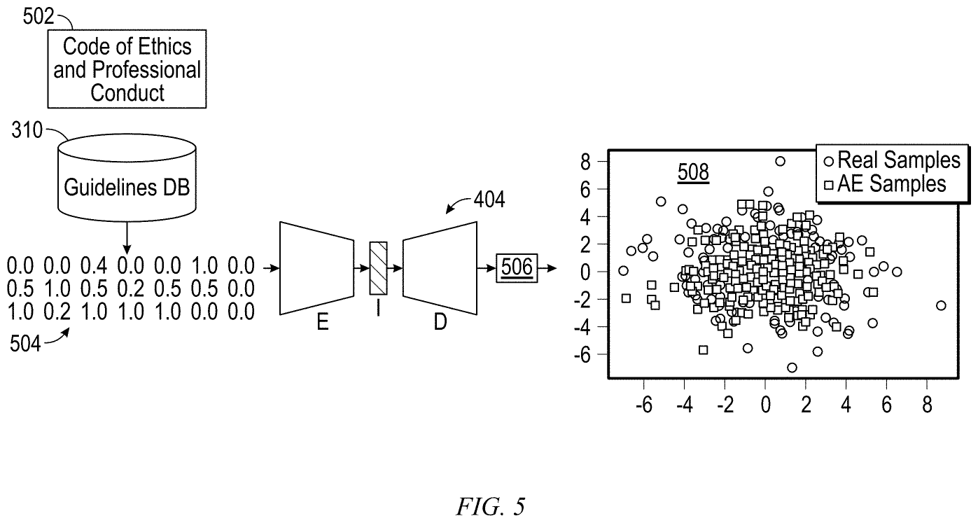

In one or more embodiments, a suitable context embedder 410 may be implemented using Word2Vec or any equivalent algorithm. When necessary, a many-to-many recurrent network (LSTM) 406 transcribes generated/encoded guideline content to other language(s). “Transcribes” refers to the translation of a text document, specifically, the virtual guideline, from one language to another. For example, a virtual social guideline in the English language could be generated from a physical office guideline and it will be transcribed to a virtual social guideline in the French language. For example, this may be useful in embodiments that back-translate machine-readable virtual social guidelines 506 (shown in FIG. 5) to human-readable formats. In one or more embodiments, the guidelines extractor 302 incorporates automatic modification of social code guidelines for an event or a company according to event context (e.g., conference, meeting, social event, etc.), participants' profiles, content being discussed, locations, etc. The context information is used as input to the recurrent attention-based encoder-decoder framework 404 that generates the guidelines. The recurrent part represents the continuous nature of the virtual event over the scheduled time, attention-based approach helps to focus on the part of the generation that aligns with the context. For example, for a specific company, attendees could be required to raise their hand or ask for permission to get access or provide their input in a serious business meeting context. On the other hand, similar attendees could be provided open access and encouraged to participate at any moment they wish in social activity (e.g., virtually celebrating employee's birthday). As a result, an attendee speaking instantaneously (without permission) and jokingly will be flagged as a counter-productive incident in the business meeting context but not in social activity context.

FIG. 5 depicts in more detail inputs and outputs of the encoder-decoder 404 of the guidelines extractor 302. The sentence parser 408 and the word embedder 410 (not shown in FIG. 5) convert physical-world guidelines 502 from the guidelines database 310 to machine-readable form 504. Then the encoder-decoder 404 produces a new set of virtual-presence solution guidelines 506 from the machine-readable physical-world guidelines 504. In a principal-component analysis graph 508, the virtual-presence solution guidelines are compared to the physical-world guidelines.

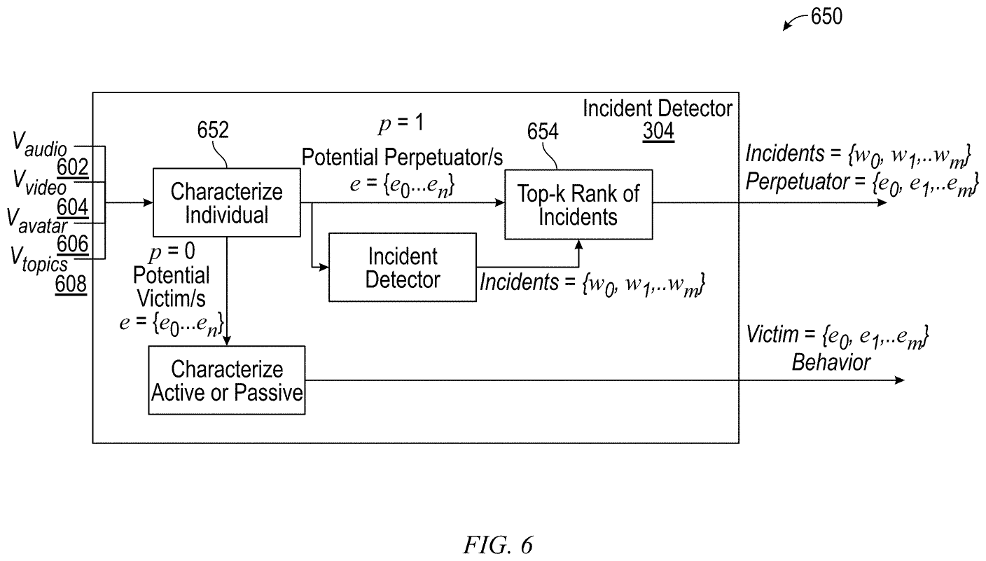

FIG. 6 depicts the incident detector 304, components thereof, and a method 650 that the incident detector implements. In one or more embodiments, the incident detector 304 includes a multi-classifying neural network (multi-classifier) that receives transactions data (e.g., an audio stream 602, a video stream 604, an avatar gesture/motion command stream 606, a chat topics stream 608) from the virtual presence solution 320. All input vectors (audio, video, avatar, and topics) correspond to temporal data, and a timestamp indexes each element of each vector. In the case of audio, in one example, raw waveforms can be compressed and synthesized with a GAN (generative adversarial network) for later use from speech to text modules. A vector regarding avatar information contains a dictionary with (position in the screen of the avatar, set of avatars interacting at a given time, and a set of activities being performed by the avatar). The topics discussed in a chat box are also assigned a timestamp; these topics are extracted from the text format by standard methods such as Latent Dirichlet models. That is, the incident detector 304 receives time-series data with audio information (v_{audio}) 602, video information (v_{video}) 604, sequence of avatar actions (vₐᵥₐₜₐᵣ) 606, and modeling topics of message chat (v_{topics}) 608. With this input, at 652 the incident detector 304 characterizes each individual in the current context (LSTM binary classifier) as potential perpetrator/s or potential victim/s or neither. To do this, the incident detector 304 generates a set of embeddings (e={e₀ . . . eₙ}) for each individual. In the case of potential perpetrators, at 654 the incident detector 304 ranks the incidents with respect to the guidelines 500 to inform severity of potential interventions.

The multi-classifying incident detector 304 may match portions of the streams to the guidelines 500 developed by the guidelines extractor 302. As ground truth for training the incident detector 304, use a database of prior transactions deemed by subject matter experts to match/offend against the guidelines 500. Each detected incident is assigned with a score wₘ estimated by a weighted regressor. In the case of potential victims, assess if the person will present a formal complaint or not (behavior), so the assistance to the victim can be adapt to each context. For this, the incident detector 304 can use a binary classifier (tree based methods). The incident detector 304 also classifies individual participants as potential victims or potential perpetrators based on matching portions of each participant's stream and portions of neighboring streams to the guidelines 500 that are developed by the guidelines extractor 302 (predicting patterns of guideline violation based on monitored ongoing conversations/interactions on the virtual environment for the event (e.g., conference breakout session)). In one or more embodiments, the guidelines monitor 96 further identifies ‘passive’ counter-productive interactions. For example, a group of users could consistently deny a particular user (a victim) a fair chance to participate or provide input or even worse ignore comments/questions from this particular user, without actively expressing themselves or otherwise providing an active (editable) data stream. In response to characterizing a participant as a potential victim, or as a potential perpetrator, the incident detector 304 alerts the interventions generator 306. That is, the set of incidents scores, potential perpetrators and victims (with associated behavior) are passed as input to the Intervention and Report Generator modules.

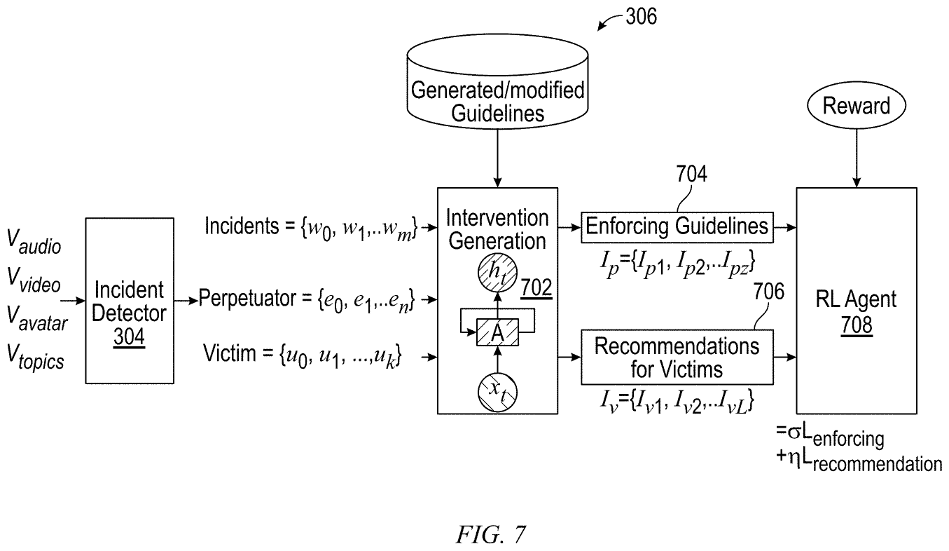

FIG. 7 depicts the interventions generator 306 and components thereof. In one or more embodiments, the interventions generator 306 comprises a long-short-term-memory (LSTM) neural network 702 that generates interventions of enforcing guidelines 704 and victim recommendations 706 using a reward-based framework, where the system is penalized during generation of incorrect interventions and rewarded when the correct interventions are generated. Correct interventions resulting reduction in the virtual environment where the social guidelines are adhered. A reinforcement learning (RL) agent 708 trains the LSTM 702 to generate the optimal set of both enforcing interventions and recommendations, and the training aims to reduce the loss incurred due to errors in generating the correct interventions as

Lₜₒₜₐₗ=σL_{enforcing}+ηL_{recommending}

where the losses of enforcing or recommending as promoted by the LSTM 702 are determined by reference to a ground truth of what is recommended by the modeled guidelines. In one embodiment, LSTM is employed to address the continuous nature of the virtual event, and a database (with previous virtual activities, adherence score, interventions applied) is used to train the model, which learns generating the optimal interventions using a reward-based learning framework via reinforcement-learning. In cases where no such ground truth labels are available, active learning is employed that requires a few human-annotated labels and the system learns actively from these labels. σ, η are weighting factors. Exemplary interventions could include:
Triggering a specialized “chatbot agent” to educate individuals showing certain degree of deviation from the specified guidelines for the event based on their interaction patterns, for example, displaying the event guidelines to the individual(s).
Automatically expelling a user or a group of users from a virtual event when detected bullying/intimidation/personal attacks, unnecessary disruption of talks or other conference events.
Temporarily suspending an ongoing virtual event.
Establishing a secure channel for a victim to automatically report issues in trustworthy manner and customized AI chatbot can be initiated to provide personalized guidance.
Generating an alert and sending to law enforcement based on the degree of violation and/or permission of the victim.
Completely cancelling an ongoing event.
Interrupting or prohibiting implementation of a user input so that an intended or unintended offense does not happen.

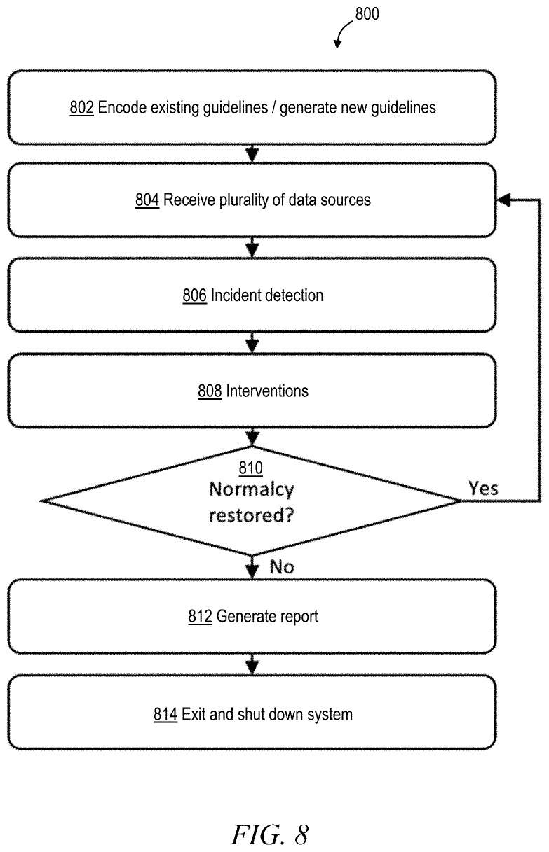

FIG. 8 depicts a method 800 that is implemented by the guidelines monitor 96 in one or more embodiments. At 802, encode existing guidelines or generate new guidelines. At 804, receive a plurality of data-sources, e.g., from the virtual presence solution 320. At 806, carry out incident detection, e.g., using the incident detector 304 to compare data from the virtual presence solution 320 to the guidelines. At 808, generate interventions that enforce the guidelines, e.g., using the interventions generator 306. At 810, check whether the interventions generator 306 has restored a status where the virtual guidelines are followed, and non-productive incidents are avoided/appropriate behavior is exhibited. If not (NO branch of decision block 810), at 812 generate a report and at 814 exit the system—shutting down the virtual presence solution 320. If appropriate behavior has been restored (YES branch of 810), loop back to 804 and check new data.

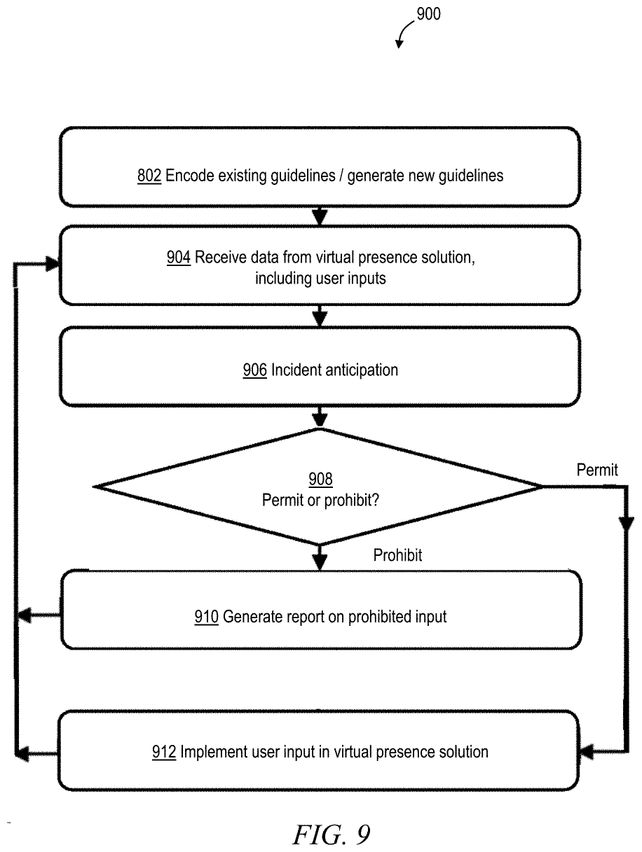

FIG. 9 depicts a proactive method 900, applicable to active data streams, that is implemented by the guidelines monitor 96 in one or more embodiments. At 802, encode existing guidelines or generate new guidelines. At 904, receive data from the virtual presence solution 320, including interception of user input (e.g., voice signal, avatar motion commands) before the virtual presence solution 320 implements that input by publishing it to other users. At 906, carry out incident anticipation by evaluating the user based on the guidelines, e.g., using the incident detector 304. At 908, determine (e.g., based on the severity of the incident and existing guidelines) whether to permit or prohibit implementation of the user input. At 910, if the user input is prohibited (in response to the incident detector 304 tripping on some aspect of the input), generate a report regarding the prohibited user input and the guideline(s) it offends; prohibit implementation of the user input by at least one of muting an output audio stream and masking an output video stream; and then loop back to check new user input. For example, if a user speaks an inappropriate comment or makes an inappropriate gesture, the output audio and/or video stream can be edited to mute the inappropriate comment, to blank the user's video, or to mask the inappropriate gesture with something non-objectionable, e.g., a friendly emoji. At 912, if the user input is permitted, implement the user input in the virtual presence solution 320. Continue back to 904 and check new data.

In one or more embodiments, the guidelines monitor 96 displays mandatory guidelines and associated penalties when a user logs into a virtual meeting environment/virtual presence solution, and receives the user's “acknowledge” (informed consent) on reading to comply with the mandatory guidelines and associated penalties prior to allowing the user to join in the specific virtual event (e.g., conference). The guidelines monitor 96 continuously monitors ongoing conversations/interactions in a virtual presence solution for an event (e.g., conference breakout session) and establishes/predicts patterns of guideline violation. The guidelines monitor 96 further provides early signs/warnings, reminders of social guidelines and generates a penalty scheme for (potential or actual) offenders while providing a direct and easy reporting guide for victims.

Given the discussion thus far, and with reference to accompanying drawing figures, it will be appreciated that, in general terms, an exemplary method 800 or 900, according to an aspect of the invention, includes at 804 or 904, intercepting data in a virtual presence solution; at 806 or 906, classifying the intercepted data against machine-readable conduct guidelines by processing the intercepted data in a neural network; and at 808 or 908, intervening in the virtual presence solution in response to a component of the intercepted data being classified to a match with at least one of the machine-readable conduct guidelines.

In one or more embodiments, the method also includes, at 802, encoding the machine-readable conduct guidelines for the virtual presence solution, based in a database of physical conduct guidelines.

In one or more embodiments, encoding the machine-readable conduct guidelines includes natural language parsing the physical conduct guidelines by a module 408.

In one or more embodiments, encoding the machine-readable conduct guidelines further includes feeding the parsed physical conduct guidelines to an encoder-decoder framework 404.

In one or more embodiments, intervening in the virtual presence solution includes, at 908, prohibiting implementation of a user input component of the intercepted data. In one or more embodiments, prohibiting implementation of the user input component of the intercepted data comprises at least one of muting an output audio stream and masking an output video stream.

In one or more embodiments, intervening in the virtual presence solution includes, at 812, generating a report within the virtual presence solution of the component of the intercepted data that matched at least one of the machine-readable conduct guidelines.

In one or more embodiments, intercepting the data at 804 or 904 includes monitoring user input and virtual presence solution output.

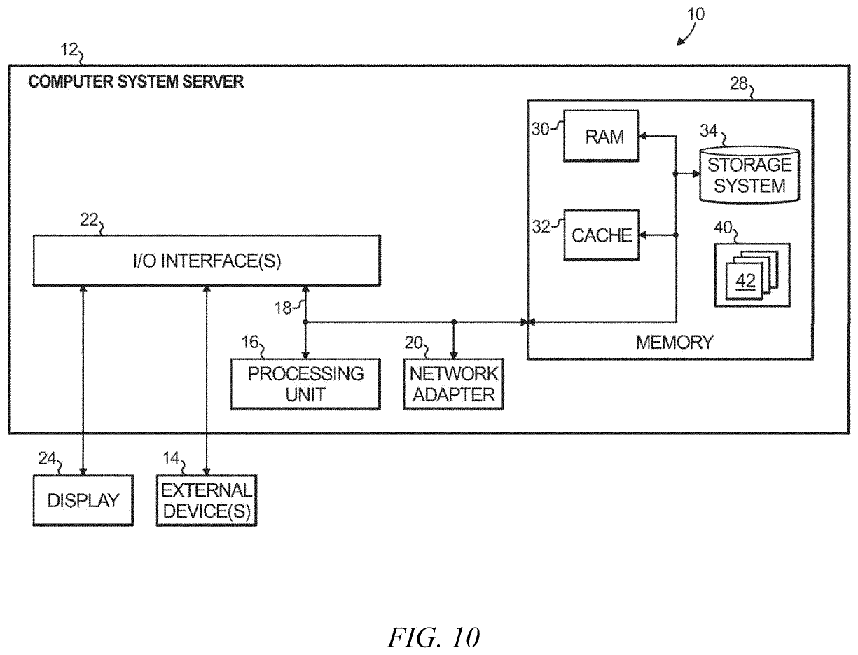

One or more embodiments of the invention, or elements thereof, can be implemented in the form of an apparatus including a memory and at least one processor that is coupled to the memory and operative to perform exemplary method steps, or in the form of a non-transitory computer readable medium embodying computer executable instructions which when executed by a computer cause the computer to perform exemplary method steps. FIG. 10 depicts a computer system that may be useful in implementing one or more aspects and/or elements of the invention, also representative of a cloud computing node according to an embodiment of the present invention. Referring now to FIG. 10, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 10, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 10) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
intercepting data in a virtual presence solution;
classifying the intercepted data against machine-readable conduct guidelines by processing the intercepted data in a neural network; and
intervening in the virtual presence solution in response to a component of the intercepted data being classified to a match with at least one of the machine-readable conduct guidelines.

2. The method of claim 1, further comprising encoding the machine-readable conduct guidelines for the virtual presence solution, based in a database of physical conduct guidelines.

3. The method of claim 2, wherein encoding the machine-readable conduct guidelines comprises natural language parsing the physical conduct guidelines.

4. The method of claim 3, wherein encoding the machine-readable conduct guidelines further comprises feeding the parsed physical conduct guidelines to an encoder-decoder framework.

5. The method of claim 1, wherein intervening in the virtual presence solution comprises prohibiting implementation of a user input component of the intercepted data.

6. The method of claim 5, wherein prohibiting implementation of the user input component of the intercepted data comprises at least one of muting an output audio stream and masking an output video stream.

7. The method of claim 1, wherein intervening in the virtual presence solution comprises generating a report within the virtual presence solution of the component of the intercepted data that matched at least one of the machine-readable conduct guidelines.

8. The method of claim 1, wherein intercepting the data comprises monitoring user input and virtual presence solution output.

9. A computer program product comprising one or more computer readable storage media that embody computer executable instructions, which when executed by a computer cause the computer to perform a method comprising:
intercepting data in a virtual presence solution;
classifying the intercepted data against machine-readable conduct guidelines by processing the intercepted data in a neural network; and
intervening in the virtual presence solution in response to a component of the intercepted data being classified to a match with at least one of the machine-readable conduct guidelines.

10. The computer readable storage medium of claim 9, wherein the method further comprises encoding the machine-readable conduct guidelines for the virtual presence solution, based in a database of physical conduct guidelines.

11. The computer readable storage medium of claim 10, wherein encoding the machine-readable conduct guidelines comprises natural language parsing the physical conduct guidelines.

12. The computer readable storage medium of claim 11, wherein encoding the machine-readable conduct guidelines further comprises feeding the parsed physical conduct guidelines to an encoder-decoder framework.

13. The computer readable storage medium of claim 9, wherein intervening in the virtual presence solution comprises prohibiting implementation of a user input component of the intercepted data.

14. The computer readable storage medium of claim 13, wherein prohibiting implementation of the user input component of the intercepted data comprises at least one of muting an output audio stream and masking an output video stream.

15. The computer readable storage medium of claim 9, wherein intercepting the data comprises monitoring user input and virtual presence solution output.

16. An apparatus comprising:
a memory embodying computer executable instructions; and
at least one processor, coupled to the memory, and operative by the computer executable instructions to perform a method comprising:
intercepting data in a virtual presence solution;
classifying the intercepted data against machine-readable conduct guidelines by processing the intercepted data in a neural network; and
intervening in the virtual presence solution in response to a component of the intercepted data being classified to a match with at least one of the machine-readable conduct guidelines.

17. The apparatus of claim 16, wherein the method further comprises encoding the machine-readable conduct guidelines for the virtual presence solution, based in a database of physical conduct guidelines.

18. The apparatus of claim 17, wherein encoding the machine-readable conduct guidelines comprises natural language parsing the physical conduct guidelines.

19. The apparatus of claim 18, wherein encoding the machine-readable conduct guidelines further comprises feeding the parsed physical conduct guidelines to an encoder-decoder framework.

20. The apparatus of claim 16, wherein intervening in the virtual presence solution comprises prohibiting implementation of a user input component of the intercepted data.
